(19) United States
(12) Patent Application Publication
(10) Pub. No.: US 2006/0055066 A1
(43) Pub. Date: Mar. 16, 2006

(54) Method of mechanically disrupting the Van der Waals attraction of a liquid to increase fuel efficiency

(76) Inventor: Joseph Louis Donnelly, Lakewood, WA (US)

Correspondence Address: Joseph Donnelly, 11302 Kendrich St SW, Lakewood, WA, 98499, US

(21) Appl. No.: 10/939,893

(22) Filed: Sep. 13, 2004

(51) Int. Cl. B01F 3/04

(52) U.S. Cl. 261/90

(57) ABSTRACT

A method of disrupting the Van der Waals attraction within a fluid, such as hydrocarbon fuel, to increase efficiency and decrease emissions in the combustion process of an internal combustion engine. This method includes introducing a compound gas such as air and a liquid such as hydrocarbon fuel through a housing with a spinning rotor to create a more ubiquitous fuel. In a preferred embodiment, the steps of disrupting the Van der Waals attraction would comprise of introducing the compound gas and liquid into a housing containing spinning rotor with imperfections on its surface. The spinning rotor produces a “water hammer” effect within the solution to allow the disruption of the Van der Waals attraction. In turn creating a greater efficiency during the combustion process of an internal combustion engine.

### TECHNICAL FIELD

This invention relates generaly to disrupting the Van der Waals attraction within a hydrocarbon fuels used in conjunction with internal combustion, jet, or any other type of engines or in any other device where the fuel is harnessed to perform a release in energy or heat by centrifugal force.

### BACKGROUND OF INVENTION

The disruption of the Van der Waals attraction in a liquid has many advantages. For example, the disruption of the Van der Waals attraction of hydrocarbon fuels allow for a more consistent and cleaner burn, increasing the efficiency and decreasing the emissions of internal combustion engines.

Prior art suggests the heating of a liquid which unto itself does not produce the desired results and can cause catastrophic results in the preferred embodiment of our invention.

Prior art suggests a mixing of two or more dissimilar fluids there is no mention of using the centrifugal forces generated by prior art for the sole purpose of disrupting the Van der Waals attraction for the enhancement of hydrocarbon fuels in the combustion process of an internal combustion engine. We can use a complex gas such as air to assist in the disruption of the Van der Waals, but are not limited to the mixing of any substance prior art suggest oxygenation of fuel prior to burning to enhance combustion efficiency, this statement does not take into consideration the disruption of the Van der Waals attraction. The oxygenation of fuel alone does not have the same results as the disruption of the Van der Waals attraction. Further Prior art suggests Atomization of fuel to enhance burning, this suggests that the device atomizes the fuel, We only plan on disrupting the van der Waals attraction so that when the fuel is atomized by the combustion source the fuel is consumed more efficiently, due to the disrupted Van der Waals attraction within the fuel.

Thus, a specific need exists for the method of mechanically disrupting the Van der Waals attraction of a liquid by causing a liquid to smash into itself and any other substance we introduce through centrifugal force. More specifically, using a rotor that may or may not have imperfections on its surface spinning in a housing that may or may not have any imperfections to increasing fuel efficiency through by disrupting the Van der Waals attraction within hydrocarbon fuel.

For clarity of disclosure and discussion, the present invention will be discussed herein, primarily in the content of its application, to the disruption of the Van der Waals attraction of a hydrocarbon fuel to enhance the efficiency and decrease the emissions of internal combustion engines.

Such an application is considered by the inventor to be the best mode of carrying out the invention. It will be understood and appreciated, however, that the method and apparatus of the invention is applicable to virtually any situation where Van der Waals attraction in a liquid need to be disrupted, for example; combining hydrocarbon fuel with other substances to manipulate the fuels characteristics, or as a method to increase the efficiency of a consumable fuel such as gas, diesel, black oil, kerosene, jet fuel, or any other liquid fuel.

Thus, the discussion of the invention herein within the context of disruptimg the Van Der Waals attraction of a liquid, more specifically, using a rotor that may or may not have imperfections on its surface spinning in a housing that may or may not have any imperfections to increasing fuel efficiency by disrupting the Van der Waals attraction within a hydrocarbon fuel to increase the efficiency and decrease the emissions within the combustion process of the internal combustion engine should not be interpreted as a limitation of the invention, but only as representing a preferred embodiment or application and best mode of carrying out the invention.

### SUMMARY OF THE INVENTION

Briefly described, the present invention is a preferred embodiment thereof, comprised of a unique and highly efficient method of disrupting the Van der Waals attraction of a liquid, more specifically, using a rotor that may or may not have imperfections on its surface spinning in a housing that may or may not have any imperfections to increasing fuel efficiency by disrupting the Van der Waals attraction within hydrocarbon fuel to increase the efficiency and decrease the emissions of the combustion process of an internal combustion engine.

The methodology of this invention, in the context of disrupting the Van der Waals attraction of liquid more specifically a hydrocarbon fuel comprises of but is not limited to the introduction of a complex gas such as air through either an external source such as a compressor, blower or pressurized line or an internal blower or compressor, to a hydrocarbon fuel with the purpose of assisting in the breaking of the Van der Waals attraction by means of a rotor which may or may not contain imperfection on its surface, which is spinning in a housing that may or may not contain imperfections. The rotor my be powered through a self contained magnetic, inductive, or mechanical manner or may simply have an external source to spin the rotor connected by shaft, belt, gear, cog or other form of connection, In turn causing the liquid to compress against its self forcing the breakdown of the Van der Waals attraction. This allows for a more efficient and cleaner burning of the fuel.

References Cited

U.S. Patent Documents

| | | |
|---|---|---|
| 3,198,191 A | August 1965 | Wyszomirski |
| 3,873,414 A | March 1975 | Rocher et al. |
| 3,948,489 A | April 1976 | Sawyer |
| 4,075,248 A | February 1978 | Marshall et al. |
| 4,273,075 A | June 1982 | Freihage |
| 4,357,931 A | November 1982 | Wolpert et al. |
| 4,781,151 A | November 1988 | Wolpert jr. et al. |
| 5,082,526 A | January 1992 | Dorris |
| 5,141,328 A | August 1992 | Dilley |
| 5,188,090 A | February 1993 | Griggs |
| 5,385,298 A | January 1995 | Griggs |
| 5,490,727 A | February 1996 | Pöschl |
| 5,552,133 A | September 1996 | Lambert et al. |
| 5,782,556 A | July 1998 | Chu |
| 5,810,052 A | September 1998 | Kozyuk |
| 5,937,906 A | September 1999 | Griggs |
| 6,365,555 B1 | April 2002 | Moser et al. |
| 6,386,751 B1 | May 2002 | Wootan et al. |
| 6,627,784 B2 | September 2004 | Hudson et al. |

### BRIEF DESCRIPTION OF THE DRAWINGS

FIG. 1. Is a sectioned view illustrating one preferred embodiment of an apparatus for disrupting the Van der Waals attraction within a liquid, such as hydrocarbon fuel according to the present invention.

FIG. 2. Is an illustration of the apparatus of FIG. 1 with the purpose of showing the modified to be used as an inductive motor.

FIG. 3. Is an illustration of the apparatus of FIG. 1 functioning in a system to break the Van der Waals attraction of a hydrocarbon fuel to increase efficiency and decrease emissions in the combustion process of an internal combustion engine.

### DETAILED DESCRIPTION OF THE PREFERRED EMBODIMENT

As mentioned above, the methodology of the present invention will be discussed within the content of its' application to disrupt the Van der Waals attraction of hydrocarbon fuel to increase efficiency and decrease emissions in the combustion process of an internal combustion engine. Which this represents a preferred application and best mode of carrying out the invention, it will be understood that the invention has numerous other applications whenever the disruption of the Van der Waals attraction is required. In this regard numerous examples of the application of the present invention in other uses will be described following the detailed description of its application to increasing efficiency and decreasing emissions of hydrocarbon fuel in the combustion process of an internal combustion engine.

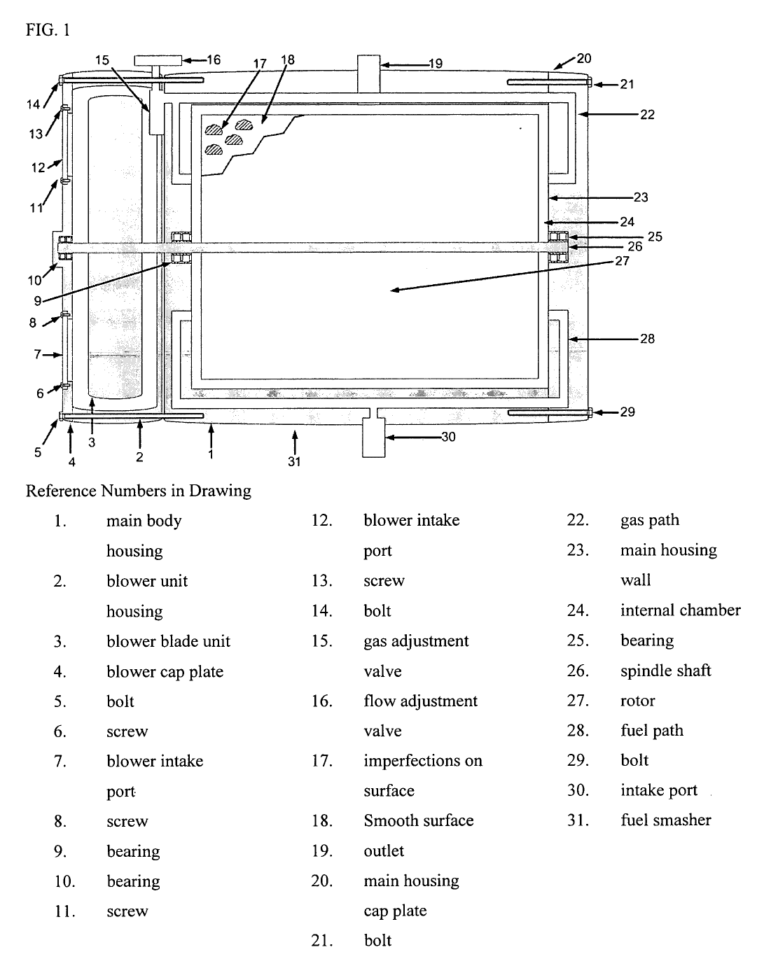

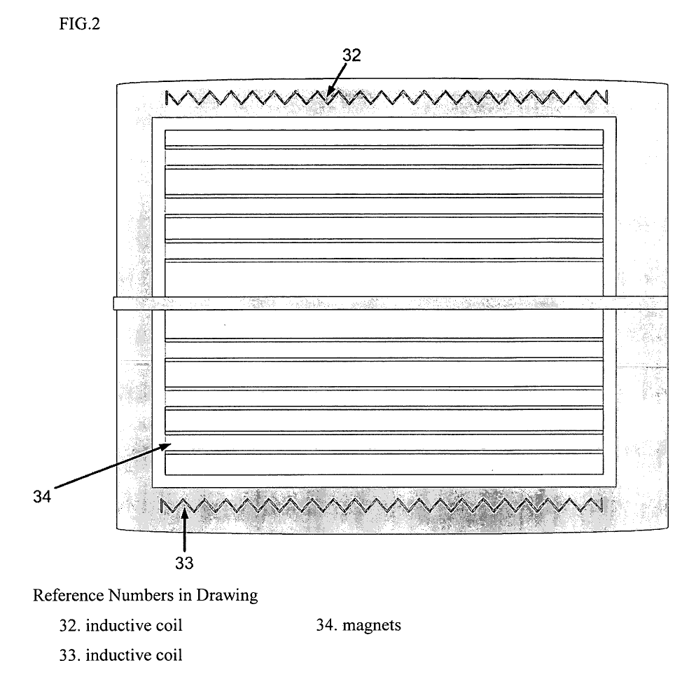

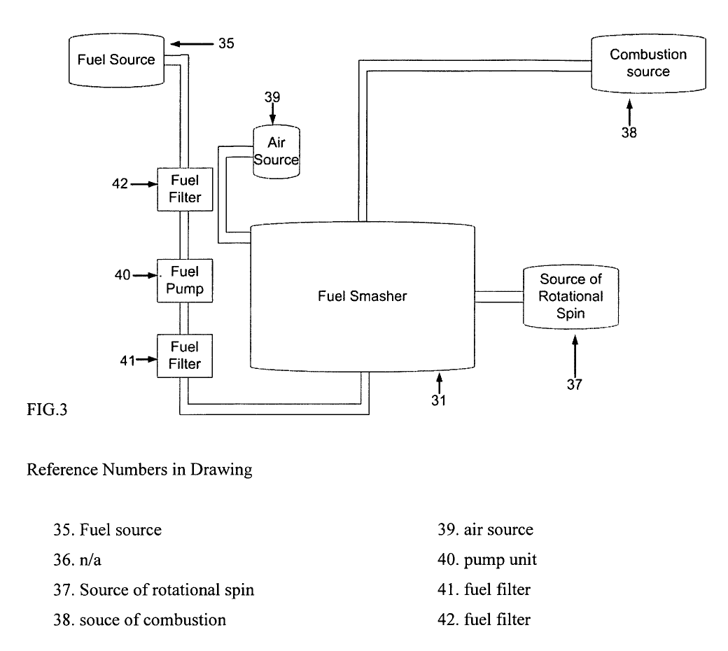

Referring now in more detail to the drawings, in which like numerals refer to like parts throughout the several views, FIG. 1 Illustrates a preferred embodiment of a Fuel smasher for carrying out the present invention. The fuel smasher 31 comprises a housing 1 a rotor 27 defining an internal chamber 24 in the illustrated embodiment the housing 1 is formed by either milling or injection molding. Capped by an end plate 20 secured in place by bolts 21, 29 there can also be added a blower unit 2-8 and 10-14 to assist the injection of air if required, otherwise an external gas source (FIG. 3) 39 may be connected to the gas adjustment valve 15 which is controlled through the gas flow adjustment valve 16. The unit may be driven by an external device by extending the spindle shaft 26 and attaching an external drive mechanism (FIG. 3) 37. The preferred embodiment would use inductive coils (FIG. 2) 32, 33 which would rotate the rotor 27 containing several magnets (FIG. 2) 34. The spindle shaft 26 runs through the rotor 27 and is supported by bearings 25, 9 and possibly 10 if the blower unit 2-8 and 10-14 is attached. The liquid is introduced through the liquid intake port 30 which is either milled or molded into the housing 1. The disrupted fuel is expelled through the outlet 19. The rotor 27 may contain imperfections 17 or may be smooth 18 depending of type of liquid. The housing walls 23 may be smooth or contain imperfections based on liquid type and rotor clearance 24. The rotor clearance 24 is determined by type of liquid and surface configuration. The blower unit 2-8 and 10-14 can be attached by bolts 14, 5. The housing 2 is either milled or injected and is capped by a cap plate 4. The cap plate 4 contains two air intake ports 7, 12 which are attached by screws 6, 8, 11, 13. The air intake ports 7, 12 contain a built in filter which can be changed by removing screws 6, 8, 11, 13. the blower blades 3 are attached the spindle shaft 26, which in this configuration is supported by bearings 10, 9, 25. The hole fuel smasher 31 is place inline of the fuel system between the fuel source (FIG. 3) 35 and the source of combustion (FIG. 3) 38. There my be required a pump unit (FIG. 3) 40 between the fuel source (FIG. 3) 35 and the fuel smasher (FIG. 3) 31 to assure proper pressure levels. There could also be a fuel filter (FIG. 3) 41, and or 42 to prevent damage to the fuel smasher (FIG. 3) 31.

I claim:

1. A method of increasing fuel efficiency through the use of centrifugal force to disrupte the van der waals attraction of hydrocarbon fuel, comprising of:
a. introducing said fuel into a chamber with a spinning rotor with or without imperfections on either or both surfaces
b. maintaining a specific speed, revolutions per minute, of said rotor through either an external source such as a directly coupled motor or some type of belted or geared mechanical system of producing a spinning force on the rotor, or rotor shaft or internally through an integrated inductive or brush motor system or electronically through a control circuit, or any combination of said methods
c. controlling the pressure within said chamber through manipulating inlet and exhaust ports orifice sizes, number of ports, or through controlling the fuel flow rate, or restricting the fuel flow rate either prior to or after said chamber.
d. maintaining proper fuel flow rate through said chamber to allow the centrifugal forces to disrupt the van der waals attraction within said fuel
e. Maintaining specific clearance between said chamber and said rotor to allow optimal disruption of van der waals attraction.
